(19) United States
(12) Patent Application Publication
(10) Pub. No.: US 2011/0310535 A1
(43) Pub. Date: Dec. 22, 2011

(54) Jean Box

(76) Inventor: Mike Dumitru Popescu, Port Reading, NJ (US)

(21) Appl. No.: 13/072,943

(22) Filed: Mar. 28, 2011

Related U.S. Application Data
(60) Provisional application No. 61/318,854, filed on Mar. 30, 2010.

(51) Int. Cl. H02B 1/44

(52) U.S. Cl. 361/648

(57) ABSTRACT

An apparatus for joining electric cables or telecommunication wires while concealing them from sight and deter tampering. Further the junction box may aid in the prevention electrical outages and fires.

The name of the parties involved in developing the Jean Box product is: Invention Resource International.

Invention Resource International is the company that assisted to launch the Jean Box idea by doing the comprehensive research and documentation, then utilizing creative promotional tools and techniques to introduce the idea to the industry in an attempt to attain a good faith review. To view the virtual prototype of the Jean Box type: www.virtual-prototype.com/?id=1135.

IRI helped to obtain provisional patent pending status (U.S. Provisional Patent Application No.: 61/318,854).

The agreement between IRA and the inventor Mike Dumitru Popescu was in effect for a period of twenty-four (24) months starting from August 2008.

### BACKGROUND OF THE INVENTION

1. Field of the Invention

The present invention relates generally to the field of boxes and more specifically relates to junction boxes.

2. Description of the Related Art

An electrical junction box is a container for electrical connections, usually Intended to conceal them from sight and deter tampering. However, wires in electrical junction boxes may become tangled and the box may radiate a significant amount of heat.

Various attempts have been made to solve problems found in junction box art. Among these are found in: U.S. Pat. No. 3,229,027 to Kindorf; U.S. Pat. No. 4,963,700 to Olsen; and U.S. Pat. No. 6,736,715 to Kuhn. This prior art is representative of junction boxes.

None of the above inventions and patents, taken either singly or in combination, is seen to describe the invention as claimed. Thus, a need exists for a reliable junction box that maintains electrical wires in an organized manner while preventing electrical outages and fires and to avoid the above-mentioned problems.

### BRIEF SUMMARY OF THE INVENTION

In view of the foregoing disadvantages inherent in the known the junction box art, the present invention provides a novel Jean Box. The general purpose of the present invention, which will be described subsequently in greater detail, is to provide a plastic junction box to join electric cables or telecommunication wires. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Jean Box, constructed and operative according to the teachings of the present invention.

FIG. 1 shows a perspective view illustrating the exterior of a Jean Box in a closed position according to an embodiment of the present invention.

FIG. 2 is a perspective view illustrating the interior Jean Box according to an embodiment of the present invention.

FIG. 3 is a perspective view illustrating another view of Jean Box according to an embodiment of the present invention.

FIG. 4 is a perspective view illustrating yet another view of Jean Box according to an embodiment of the present invention.

The various embodiments of the present invention will hereinafter be described in conjunction with the appended drawings.

### DETAILED DESCRIPTION

As discussed above, embodiments of the present invention relate to a junction box device and more particularly to a Jean Box to join electric cables or telecommunication wire while concealing them from sight and deter tampering.

Everyday, thousands of professional contractors and amateur Do-it-yourselfers may embark on a variety of construction and home improvements tasks such as building an addition onto the home, replacing paneling or flooring and installing light fixtures or other electrical wiring. Requiring varying degrees of skill, as well as a good eye, the results achieved by successfully completing these tasks may be enjoyed for years. Regardless of whether one is a professional contractor, or simply a husband and wife duo making improvements to their living space, most may agree that a broad knowledge of the task at hand is crucial to ensure the job is executed in a safe and proper manner.

For electricians and do-it-yourselfers engaged in electrical work, a working knowledge of materials at hand may be imperative as working with electricity and live wires may extremely dangerous. Electrical equipment provides light, heat, communications, and power to a home or building. Electricians and skilled Do-it-yourselfers perform electrical work by assembling, installing and connecting lighting and power systems, intercoms, signaling systems and ventilators. Electricians follow blueprints and specifications to install electrical wires, cables, conduit systems and junction boxes.

Electrical junction boxes may be utilized as containers for electrical junctions. These devices may be intended to conceal metal material and is some cases form part of electrical conduit wiring systems. Thus, these boxes may be buried in the plaster of a wall, or concealed an accessed panel or door. Unfortunately, junction boxes may be susceptible to external elements. Excessive exposure to humidity and moisture, heat or even frigid temperatures inside or outside the home may compromise the integrity of the electrical wiring and cables joined within the box. These continued exposures may result in power outages or in worse case scenarios; electrical fires.

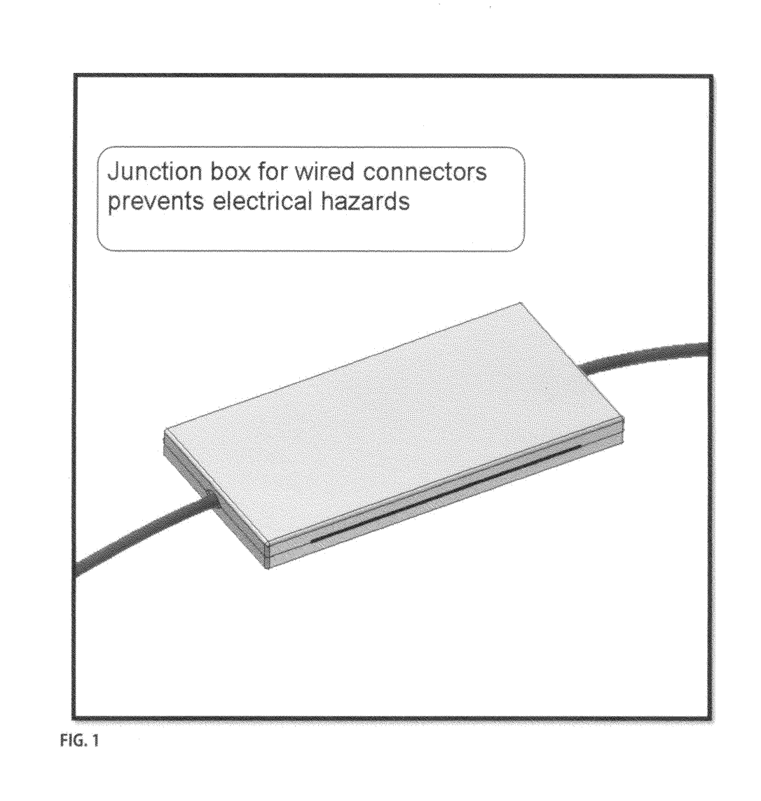

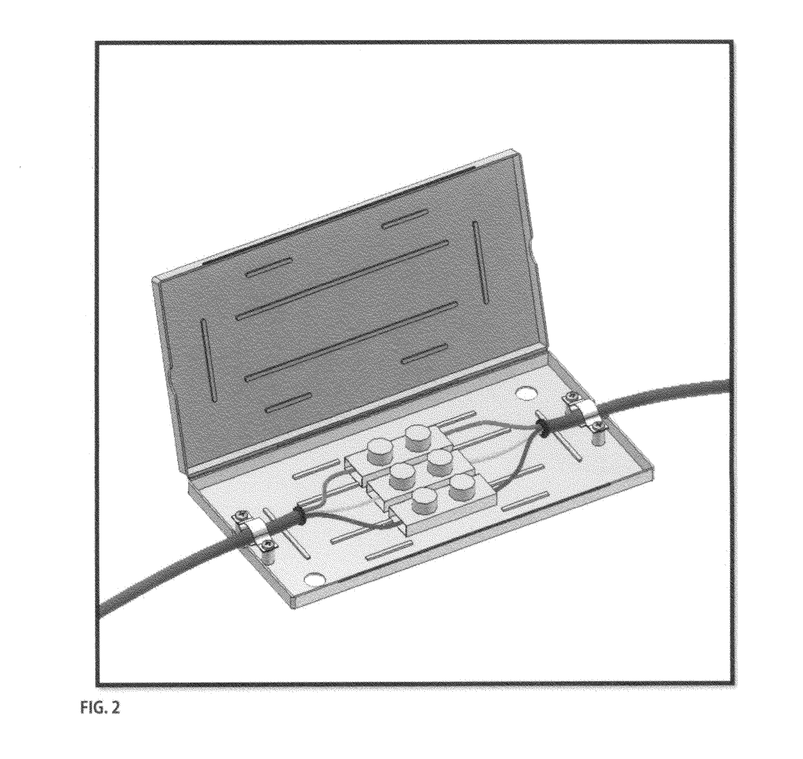

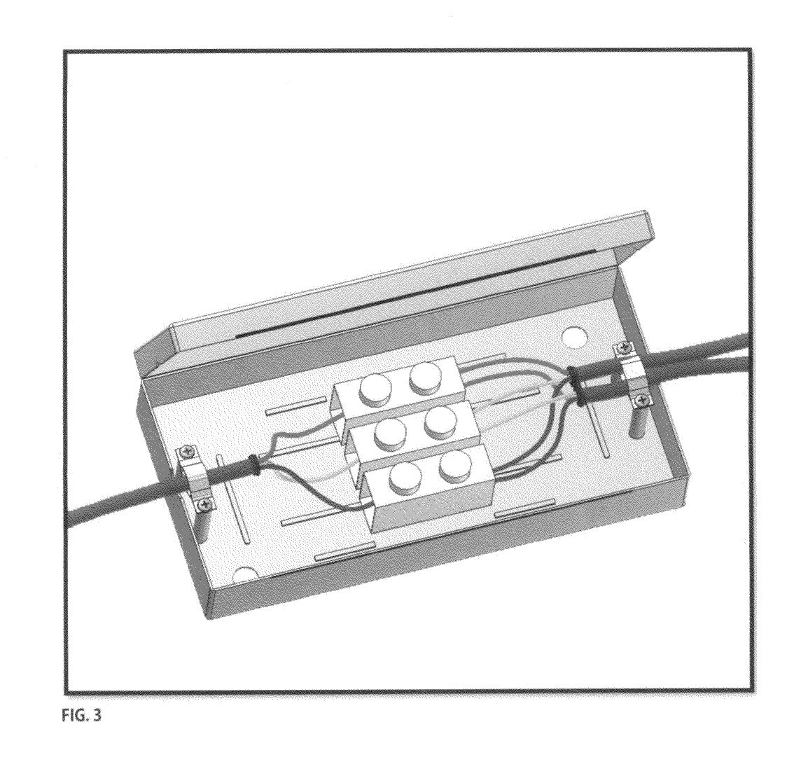

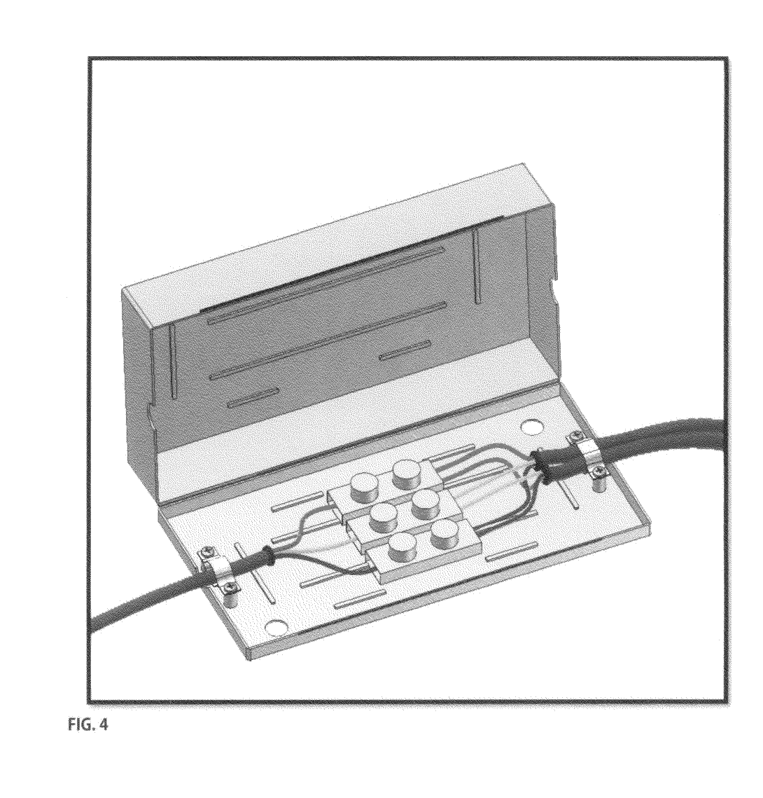

Referring now to the drawings FIG. 1-4, the Jean Box comprising a novel product offering consumers a practical solution to the aforementioned challenges. As the name implies, the Jean Box may offer electricians and household consumers alike a sensible solution to the aforementioned challenges. Simply stated, the Jean Box may be a specifically designed junction box to withstand exposure to external elements. Manufactured of a flame resistant plastic material, the Jean Box may measures approximately 3 inches in length by 2 inches in width and approximately 2 inches in total depth. Smaller and larger versions of this product may also be made available. Most notably, the interior of the Jean Box is lined with a barrier/connector strip, while a system of small screws and clamps preferably may be designed to retain cables and wiring connected within.

The Jean Box may provide a sturdy and reliable alternative to traditional junction boxes. A nonflammable junction box boasting a protective barrier/connector strip may retain electrical wires and cables, the Jean Box, may provide a more efficient method of joining electrical wires together. The Jean Box may prove particularly useful in bathrooms, basements, kitchens or other areas where excessive steam or humidity may compromise electrical wiring. As such, use of this product may prove an invaluable safety tool, increasing safety within the home and greatly reducing the threat of electrical outages and fires.

Facilitating the safe and efficient laying of wire, the Jean Box may enable electricians and others to complete their jobs in a timelier manner. Well suited for use by professional electricians and contractors, skilled do-it-yourselfers may also appreciate the significant amount of benefits the Jean Box may afford. Compromise of durable, high quality materials, the Jean Box may withstand years of continued use while still maintaining its structural stability.

An innovative product invention, the Jean Box may readily improve the design of electrical junction boxes. Affordably priced, the Jean Box may be well received by professional electricians, as well as those who participate in do-it-yourself activities, a very sizable market potential. The Jean Box is cost-effective to produce in the embodiments, as shown in FIG. 1-4.

The embodiments of the invention described herein are exemplary and numerous modifications, variations and rearrangement can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A junction box device essentially as described herein.
